(19) United States
(12) Patent Application Publication
(10) Pub. No.: US 2020/0398649 A1
(43) Pub. Date: Dec. 24, 2020

(54) METHOD AND SYSTEM FOR REDUCING EXTERIOR LIGHT GLARE OF A WINDSHIELD

(71) Applicant: Ajay Dandge, Auburn Hills, MI (US)

(72) Inventor: Ajay Dandge, Auburn Hills, MI (US)

(21) Appl. No.: 16/444,381

(22) Filed: Jun. 18, 2019

(51) Int. Cl. B60J 3/04; B60J 3/00

(52) U.S. Cl. CPC B60J 3/04; B60Y 2400/30; B60J 3/007

(57) ABSTRACT

A system and method for reducing glare includes a light sensor generating a light intensity signal corresponding to incoming light and a light engine. A glare control system includes a control module storing instructions that when executed by a processor to cause the glare control system to perform operations that include determining a color mixing based on the light intensity signal and controlling the light engine to generate anti-glare light directed toward the inside of a windshield in response to the color mixing so that the incoming light is combined with the anti-glare light to reduce glare.

### TECHNICAL FIELD

The present disclosure relates generally to an anti-glare system and, more specifically, to a method and system reducing glare from lights from outside of the vehicle that are directed to the vehicle operator.

### BACKGROUND

The statements in this section merely provide background information related to the present disclosure and may not constitute prior art.

Glare from on-coming vehicles can make it difficult for a vehicle operator to see. Sudden bright lights can make it even more difficult to see. Maintaining a position of the vehicle relative to a roadway is important. Difficulty seeing can make maintaining position more difficult.

### SUMMARY

The present disclosure provides a method for reducing glare to the vehicle operator due to oncoming lights.

In one aspect of the disclosure, a method includes determining light intensity for incoming light received through a windshield, determining a color mixing based on the light intensity of the incoming light, controlling a light engine to generate anti-glare light and directing the anti-glare light toward the inside of the windshield in response to the color mixing so that the incoming light is combined with the anti-glare light to reduce glare.

In a further aspect of the disclosure, a system for reducing glare includes a light sensor generating a light intensity signal corresponding to incoming light and a light engine. A glare control system includes a control module storing instructions, that when executed by a processor, causes the glare control system to perform operations that include determining a color mixing based on the light intensity signal and controlling the light engine to generate anti-glare light directed toward the inside of a windshield in response to the color mixing so that the incoming light is combined with the anti-glare light to reduce glare.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a side cutaway view of a vehicle having the glare control system of the present disclosure.

FIG. 2 is a partial perspective view of light engine locations within a vehicle.

FIG. 3 is a block diagrammatical view of the glare control system.

FIG. 4 is block diagrammatical view of a light engine for the glare control system.

FIG. 5 is a state diagram of the glare control system.

### DETAILED DESCRIPTION

The following description is merely exemplary in nature and is not intended to limit the present disclosure, application, or uses. For purposes of clarity, the same reference numbers will be used in the drawings to identify similar elements. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality. As used herein, the phrase at least one of A, B, and C should be construed to mean a logical (A or B or C), using a non-exclusive logical OR. It should be understood that steps within a method are executable in different order without altering the principles of the present disclosure. The teachings of the present disclosure are implementable in a system for electronically communicating content to an end user or user device. Both the data source and the user device are formable using a general computing device having a memory or other data storage for incoming and outgoing data. The memory illustratively is, but is not limited, any of a hard drive, FLASH, RAM, PROM, EEPROM, ROM phase-change memory, other discrete memory components, or any combination thereof.

Each general purpose computing device is implementable electronically in analog circuitry, digital circuitry or combinations thereof. Further, the computing device in an example includes a microprocessor or microcontroller that performs instructions to carry out the steps performed by the various system components. A content or service provider is also described. A content or service provider is a provider of data to the end user. The service provider, for example, provides data corresponding to the content such as metadata as well as the actual content in a data stream or signal. The content or service provider illustratively includes a general purpose computing device, communication components, network interfaces and other associated circuitry to allow communication with various other devices in the system.

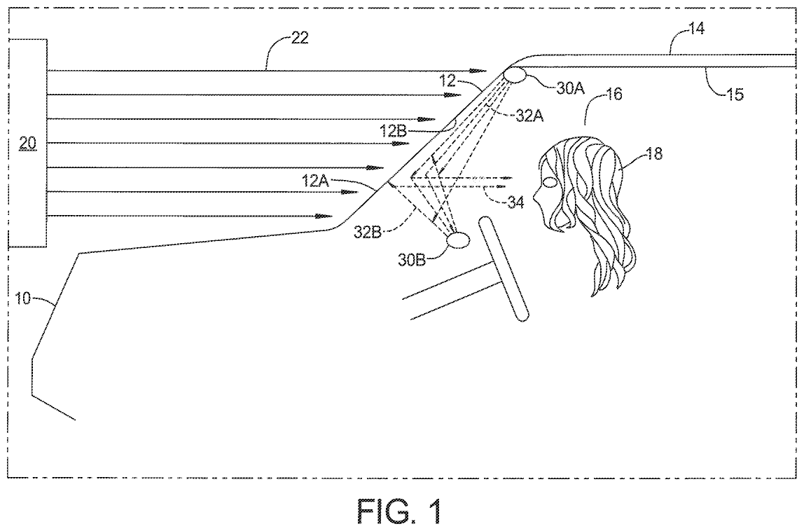

Referring now to FIG. 1, a vehicle 10 is illustrated having a windshield 12, a roof 14 having a headliner 15 and a passenger compartment 16. A vehicle operator 18 is illustrated therein. An oncoming light source 20 is illustrated outside the vehicle 10. The oncoming light source 20 generates exterior light rays 22 that are directed to the outside surface of the windshield 12. The exterior light rays 22 also enter the vehicle 10 through the windshield 12 and viewed by the operator 18. When the oncoming light enters though the windshield 12 the light in referred to as incoming light. The exterior light rays 22 provide visibility problems for the vehicle operator 18. One or more light engines 30A and 30B direct light to an interior surface 12B of the windshield 12. The light engines 30A and 30B are sometimes collectively referred to as light engine 30. The light engine 30A generates interior light rays 32A. The interior light engine 30B generates light rays 32B. The light rays 32A and 32B are directed toward the interior surface 12B of the windshield 12 where they are combined with the incoming light rays 22 and reflected to form a plurality of combined light rays 34 that are directed to the vehicle operator 18.

The combined light rays 34 that are formed use a color mixing to reduce the amount of glare from the exterior light rays 22. Color mixing is the combination of light rays from the light engines 30 that are used to cancel or minimize glare from oncoming light rays, the amount of color mixing varies depending on the intensity of the light bounces within the light engines 30 as described below.

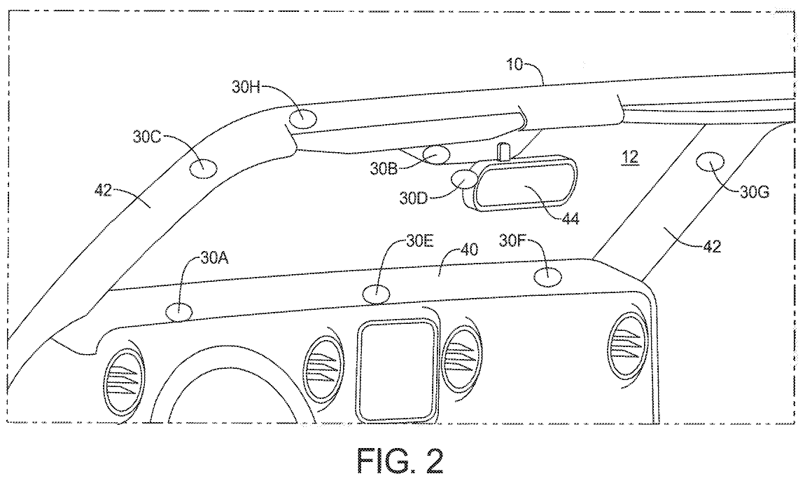

Referring now to FIG. 2, a partial perspective view of vehicle 10 is illustrated to illustrate potential locations for light engines 30A-30G. Light engines 30A, 30E and 30F are located on the surface of the instrument panel 40 of the vehicle 10. Light engines 30C and 30G are located on the A pillars 42 of the vehicle 10. Light engine 30D is located on a rearview mirror 44. Light engine 30H, in one example, is located at the intersection of the roof 14 and the windshield 12 in the area of the headliner 15 of the vehicle 10. One or more light engines 30A-30H are used to direct light toward the interior surface 12B of the windshield 12. Of course, the location and number of light engines 30 varies based upon various factors including the color of the vehicle, the composition of the windshield 12, the actual geometry of the windshield 12, the A-pillars 42, instrument panel 40 and the roofline of the vehicle 10.

The light engines 30A-30H generate anti-glare light that is directed toward the windshield 12 and in combination with incoming light reduces the amount of glare due to the color mixing.

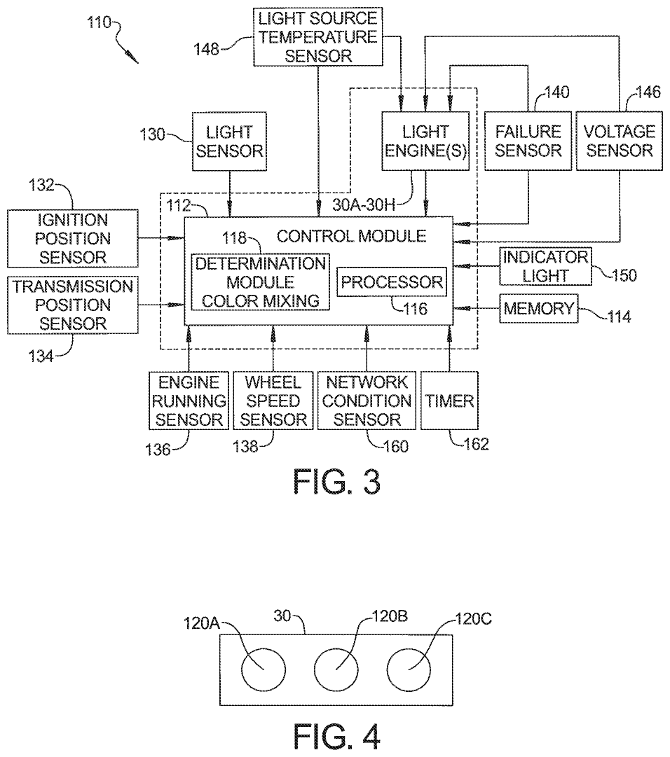

Referring now to FIG. 3, a block diagrammatic view of a glare control system 110 is illustrated. The glare control system 110 has a control module 112 that is microprocessor-based. The control module 112 is in communication with a memory 114 that stores instructions by a processor 116 located within the control module 112. The control module 112 also has a color mixing determination 118 that is used to determine the color mixing of the light engines 30A-30H.

The light engines 30A-30H comprise a plurality of light sources such as those illustrated in FIG. 4. The light engines 30A-30H are represented by light engine 30 of FIG. 4. A plurality of LED (light emitting diodes) light sources 120A, 120B and 120C are set forth within the light engine 30. The light engines 30A-30C, in this example are LED lights. Each of the LED lights has a different wavelength or color of light emitted therefrom. In this example, light source 120A is a red LED, light source 120B is a green LED and light source 120C is a blue LED. Alternately, the light sources 120A, 120B and 120C are implementable as one LED capable of producing light in all three colors. The amount of light from the light engine varies depending on the amount of sensed light.

Referring back to FIG. 3, the light sources are controlled by the control module 112 and in particular, to the color mixing determination module 118 based on various inputs and design configuration. A combination of light from different light sources are combined with the incoming light to reduce glare.

The light engines 30A-30H are controlled to generate anti-glare light based upon various sensed inputs including the input from a light sensor 130 that senses an amount of light directed to the windshield 12 of the vehicle 10. The light sensor 130 is located within the vehicle 10 and generate a signal that corresponds to an amount of light received. For example, an amount of lumens is measured from the incoming light based upon the amount of lumens the control module 112 generates control signals for the light engines 30A-30H as will be described in more detail below.

An ignition position sensor 132 is in communication with control module 112. The ignition position sensor 132 provides the control module 112 with a signal corresponding to the position of the ignition. For example, when the ignition is in a run position the ignition position sensor 132 generates a run signal. The ignition position sensor 132 generates a signal corresponding to accessory mode when the vehicle 10 is not running. The present disclosure provides a system suitable for operating during the vehicle 10 run mode.

A transmission position sensor 134 is in communication with control module 112. The transmission position sensor 134 generates a transmission position signal corresponding to the position of the transmission. For example, the transmission position sensor 134 generates a signal corresponding to park, drive, neutral, reverse and other positions of a transmission. The glare control system 110 operates when the transmission position sensor 134 is in a particular position such as a forward driving position.

An engine running sensor 136 generates an engine running signal that is communicated to the control module 112 when the engine is running.

A wheel speed sensor 138 generates a wheel speed signal that is communicated to the control module 112. The wheel speed signal corresponds to the wheel speed of one or more wheels of the vehicle 10. Illustratively, an average wheel speed of all the wheels of the vehicle is indicated. As mentioned above, the glare control system 110 operates when the vehicle 10 is in a forward moving condition.

A failure sensor 140 generates a failure signal when one or more of the light sources 120 within the light engines 30 fail. The failure sensor 140 communicates the failure signal to the control module 112. A voltage sensor 146 is in communication with the light engine 30 and generates a signal corresponding to the amount of voltage provided to the light engines 30. For example, the voltage sensor 146 generates a voltage sensor signal corresponding to an excess amount of voltage provided to the light engines 30. The voltage sensor signal is referred to as an over-voltage signal. The voltage sensor signal also generates an under-voltage signal corresponding to the voltage to the light sources being too low.

An indicator light 150 is provided in communication with the control module 112. The indicator light 150 generates a signal that indicates a fault of the glare control system 110. For example, the indicator light 150 is illuminated when the failure sensor 140 and/or the voltage sensor 146 indicates a failing condition of the light engines 30. The indicator light 150 illustratively indicates that service is required or that the glare control system 110 is not functioning properly.

A light source temperature sensor 148 is in communication with the control module 112. The light source temperature sensor 148 generates a signal corresponding to the temperature at the light engines 30. By way of example, one or more light source temperature sensors 148 are used. For example, a light source temperature sensor 148 is provided at each of the light sources or at each of the light engines 30. The failure sensor 140, the voltage sensor 146, and the temperature sensor 148 are referred to as fault sensors.

A network condition sensor 160 generates a network condition sensor that corresponds to the controller area network (CAN). Each of the components illustrated in FIG. 3 is illustratively communicated to or from the control module 112 through a controller area network. The network condition sensor 160 may indicate various types of controller area network conditions such as a parity error, a checksum error or a data error. Each of the errors mentioned above corresponds to an undesirable communication condition within the controller area network.

A timer 162 is also in communication with the control module 112. The timer 162 times various conditions such as an amount of time after an over-voltage condition or under-voltage condition is received, as will be described in more detail below.

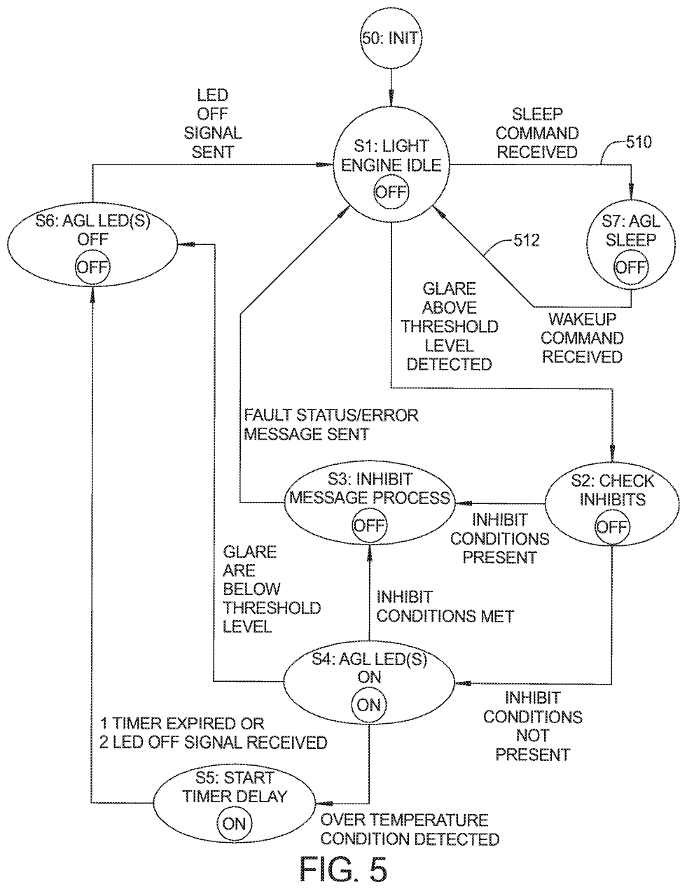

Referring now to FIG. 5, state diagram S0 of the system provided as a transition to state S1. Initially an ignition position sensor signal and a transmission sensor is monitored before transitioning to state S1. For example, when the ignition position sensor signal indicates the vehicle 10 is about to be operated such as when a key is present, and the transmission position sensor signal indicates the vehicle 10 is in park, the system then transitions to state S1. In state S, the light engines 30 are at idle generating no light. A sleep command is generated when the system receives no further inputs from state S1. The glare control system 110 is thus is in a sleep mode. A wakeup command signal 512 is generated in state S2 when the engine is running and the wheel speed is above a predetermined wheel speed. That is, both the engine running sensor 136 and the wheel speed sensor 138 are used to generate the wakeup command signal 512. In state S1 the system exits the sleep mode to monitor the glare. State S receives the output of the light sensor 130 illustrated in FIG. 3 to determine if the incoming light is above a predetermined amount. In one constructed embodiment, the light intensity threshold for activating the glare control system 110 was set at 7500 lumens. Typically, low beam lights entering the vehicle 10 are about 1000 lumens whereas high beam lights are around 9000 lumens; in this example. When the amount of light at the light sensor 130 is above the light intensity threshold state S2 is initiated. In state S2 inhibit conditions are monitored prior to illuminating the light engines 30. In a practical embodiment, the inhibit conditions are continually monitored. For example, the inhibit conditions illustratively include one or more of an LED failure signal, a network parity error, a network checksum error, an over-voltage condition at the light engines or the like. The network conditions are determined from the network condition sensor 160 of FIG. 3. When inhibit conditions are present state S3 generates an inhibit message and the indicator light 150 is illustratively illuminated. After state S3, state S1 is illustratively repeated.

Referring back to state S2, when the inhibit conditions are not present state S4 activates the light engine or engines. The amount of activation of the light engines 30 is based upon the intensity of the light at the light sensor. That is, the amount of color mixing is also be changed based upon the light sensor 130. The amount of light from the various light sources 120A-120C for each of the light engines 30 is determined. As mentioned above, the amount of color or the change in color mixing is changed based upon various design aspects of the vehicle including the angle of the windshield 12, the materials that compose the windshield 12, the colors of the instrument panel 40 and other components around the windshield 12. It has been found with testing amounts such as eighty percent red LED illumination, ten percent mixing from a blue LED and 10 percent from a green LED is very suitable to reduce glare. The total light generated from the light engines 30 was about 450 lumens in a constructed example. The value of lumens is fixed in this example. In another example, amount of light output from the light engine is varied depending on the intensity or amount of the incoming light. Lower sensed incoming light has lower light engine output whereas higher sensed light has higher light engine output. As mentioned above, the vehicle geometry materials and the relationship of the same in some cases require some variations to the light output for different vehicles. The combination of the light from the light sources 120A-120C combine with the incoming light to reduce the overall amount of glare received at the vehicle operator 18.

After step S4, step S5 is activated when an over temperature condition is determined from the light source temperature sensor 148. The timer 162 is activated when the temperature sensor signal indicates an over temperature condition. State S6 is activated when the timer signal expires or the LED or light source is turned off.

After state S6, state S1 is re-entered. State S6 is also entered when the glare from the light at the light sensor 130 is below a pre-determined amount of light intensity.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

1. A method comprising:
determining light intensity for incoming light received through a windshield;
determining a color mixing based on the light intensity of the incoming light; and
controlling a light engine to generate anti-glare light and directing the anti-glare light toward the inside of the windshield in response to the color mixing so that the incoming light is combined with the anti-glare light to reduce glare.

2. The method of claim 1, wherein determining light intensity comprises determining light intensity from a light sensor.

3. The method of claim 1, wherein determining light intensity comprises determining light intensity from a light sensor mounted on a windshield.

4. The method of claim 1, wherein prior to determining the color mixing comparing the light intensity to a light intensity threshold and wherein controlling the light engine is performed in response to the light intensity threshold.

5. The method of claim 1, wherein controlling the light engine comprises controlling light emitting diodes of the light engine.

6. The method of claim 5, wherein controlling the light emitting diodes comprises controlling light emitting diodes of different colors.

7. The method of claim 6, wherein controlling the light emitting diodes of different colors comprises controlling a red light emitting diode, a green light emitting diode and a blue light emitting diode.

8. The method of claim 1, wherein controlling the light engine comprises controlling light emitting diodes directing light from a headliner.

9. The method of claim 1, wherein controlling the light engine comprises controlling light emitting diodes directing light from an instrument panel.

10. The method of claim 1, wherein controlling the light engine comprises controlling light emitting diodes directing light from a rear view mirror.

11. The method of claim 1, wherein controlling the light engine comprises controlling light emitting diodes directing light from an A-pillar.

12. The method of claim 11, wherein controlling the light emitting diodes comprises controlling a red light emitting diode, a green light emitting diode and a blue light emitting diode.

13. The method of claim 1, wherein controlling the light engine includes controlling the light engine to generate the anti-glare light by using a first amount of red light, a second amount of green light and a third amount of blue light.

14. A system comprising:
a light sensor generating a light intensity signal corresponding to incoming light;
a light engine;
a glare control system comprising a control module storing instructions that when executed by a processor to cause the glare control system to perform operations comprising:
determining a color mixing based on the light intensity signal; and
controlling the light engine to generate anti-glare light directed toward the inside of a windshield in response to the color mixing so that the incoming light is combined with the anti-glare light to reduce glare directed to a vehicle operator.

15. A system as recited in claim 14, wherein the light engine comprises a red light emitting diode, a green light emitting diode and a blue light emitting diode.

16. A system as recited in claim 14, wherein the anti-glare light is generated by using a first amount of red light, a second amount of green light and a third amount of blue light.

17. A system as recited in claim 14, wherein the light engine is disposed on an instrument panel.

18. A system as recited in claim 14, wherein the light engine comprises a plurality of light engines.

19. A system as recited in claim 14, wherein the glare control system comprises a plurality of fault sensors for disabling the light engine.

20. A system as recited in claim 14, wherein a plurality of fault sensors comprises a voltage sensor and a temperature sensor.
